(19) United States
(12) Patent Application Publication
(10) Pub. No.: US 2003/0117707 A1
(43) Pub. Date: Jun. 26, 2003

(54) Light-scattering film and liquid crystal device using the film

(76) Inventors: Tatsuo Uchida, Miyagi (JP); Hiroyuki Takemoto, Hyogo (JP)

Correspondence Address: BIRCH STEWART KOLASCH & BIRCH, PO BOX 747, FALLS CHURCH, VA, 22040-0747, US

(21) Appl. No.: 10/275,317

(22) PCT Filed: Mar. 4, 2002
(86) PCT No.: PCT/JP02/01977

(30) Foreign Application Priority Data
Mar. 13, 2001 (JP) 2001-70534

(51) Int. Cl. G02F 1/13; G02B 5/30; G02B 27/28

(52) U.S. Cl. 359/492; 359/500; 349/194

(57) ABSTRACT

A light-scattering film 10 is obtained by subjecting a birefringent material in a resin layer to orientation treatment, in which at least one component selected from a transparent resin 6 and a scattering material 7 is the birefringent material (e.g., a birefringent resin, a liquid crystalline material). According to the light-scattering film, in the case where a linear polarized light in which a vibrating direction and a propagating direction exist in a plane containing a surface-directional axis of the film and a thickness-directional axis of the film is incident at a film surface, the rectilinear transmittance of the incident light shows maximum at an oblique incident direction to the film surface (e.g., incident angle of 20 to 89°). The rectilinear transmittance of the incident light from a direction perpendicular to the film surface is 0 to 30%, and the rectilinear transmittance of the incident light from an oblique direction having an incident angle of 40 to 70° to the film surface is 50 to 100%. Directivity in a light-scattering property of the light-scattering film is improved, and even when an incident light comes from an oblique direction, brightness of the display surface from a front direction is improved. Therefore, the film is useful for employing in combination with a polarized plate of the liquid crystal display apparatus.

### TECHNICAL FIELD

The present invention relates to a light-scattering film utilized for a variety of optical apparatus, and a liquid crystal display apparatus using the film.

### BACKGROUND ART

In a variety of optical apparatus such as a backlight unit for a transmittable liquid crystal display apparatus, and a reflective liquid crystal display apparatus, a light-scattering film has been utilized for an effective use of a light source. The light-scattering film has need of not only brightness of a display surface but also light-scattering properties excellent in brightness uniformity to accept requests as high luminance and low electric power consumption.

A conventional light-scattering film has a structure in which resin beads varying each other in refraction index are dispersed in a transparent matrix resin, and a light-scattering property of the film accords to Gaussian distribution in principle. Therefore, a scattered light is consequently scattered in direction other than a viewing direction, and brightness falls short in the viewing direction of a viewer on a display surface. Moreover, a particulate-dispersed light-scattering sheet has a property that a scattered light spreads symmetrically with a rectilinear transmitting direction of a light (or an incident direction of a light) as an axial center (scattering center). That is, a conventional light-scattering film has a property that a bottom of a light intensity (brightness) is spread out in a distribution of a scattered-light intensity, as a result, it is impossible to enhance a light intensity (brightness) on a viewing direction of a viewer.

Therefore, recently, a directional light scattering, in which a scattered light is directed near a viewing direction of a viewer (a visual axis direction) and the viewer feels bright sufficiently, has been required. Moreover, in a reflective liquid crystal display apparatus, a shift of a scattering center to the viewing direction, so called axial shift (off-axis), has been increasingly required for scattering an external light further efficiently in the viewing direction. However, there is no having such a property in a conventional light-scattering film in principle.

As a structure having a possibility that expresses such an off-axis property, there is proposed a process for obtaining such a structure by slanting a reflection electrode disposed in reverse of a liquid crystal cell or by utilizing holography (The synopsis of Lectures at Japanese Society of Liquid Crystal Science, 1998). However, since these production processes are complex, the production cost is very expensive and therefore it is difficult to produce in large quantities substantially.

Japanese Patent Application Laid-Open No. 2000-338311 discloses a light-scattering sheet having an anisotropic scattering property that an incident light having a specific angle is transmitted with causing scatteration and an incident light having other angle is transmitted directly without causing scatteration, wherein an elliptical-shaped small piece different in refraction index is dispersed into the sheet with the major and minor axial directions arranging, and the light-scattering sheet is formed as having gradation derived from high and low of refraction index. This specification also discloses that the light-scattering sheet is disposed in front of a liquid crystal panel (viewer side). The light-scattering sheet having such a property is produced by aligning a rough face or light-diffusing material, a convex lens, a mask having an aperture (an elliptical-shaped mask in which the shape of the aperture is a zonal shape having a given width), a convex lens, and a photographic sensitive material sequentially in alignment, and recording a striped pattern having light and shade, onto the photographic sensitive material, which is caused when high coherent light is scatter-reflected or transmitted by the rough face or light-diffusing material. Used as the photographic sensitive material is a photographic sensitive material for volume-mode hologram in which refraction index varies between an exposure part and a non-exposure part of a laser beam. However, the production process of this light-scattering sheet is complex and it is necessary to use a special photographic sensitive material utilizing hologram.

It is, therefore, an object of the present invention to provide a light-scattering film capable of effectively inhibiting spread of a bottom in distribution of a scattered light intensity and having a light-scattering property exhibiting enhanced directivity, a process for producing the same, and a liquid crystal display apparatus using the same.

It is another object of the present invention to provide a light-scattering film utilized for displaying a display surface brightly even when an incident light comes from an oblique direction, a process for producing the same, and a liquid crystal display apparatus using the same.

It is further another object of the present invention to provide a light-scattering film which ensures off-axis property of a light-scattering property on an incident light from an oblique direction, and a liquid crystal display apparatus using the same.

### DISCLOSURE OF INVENTION

The inventors of the present invention did much research to accomplish the above objects and focused that a light-scattering film need only have an effective property in a linear polarized light because polarization is utilized in a liquid crystal display apparatus in principle. As a result, the inventors found that a light-scattering sheet comprising a birefringent material as at least one component selected from a transparent resin and a scattering material or component (such as a particulate material) realizes high transmittance at a specific incident angle in light-scattering property, so that the sheet can have an off-axis property in a linear polarized light of an oblique incidence. The present invention has been developed on the basis of the above findings.

That is, the light-scattering film of the present invention comprises a light-scattering layer containing a transparent resin and a scattering material (or scattering component), wherein a rectilinear transmittance of an incident light exhibits a maximum at an oblique incident direction to the film surface when a linear polarized light, in which a vibrating (vibration) direction and a propagating (propagation) direction exist in a plane containing an axis of a surface direction of the film and an axis of a thickness direction of the film, is incident on the film surface. In such a light-scattering film, for example, a plurality of transparent resins forming the transparent resin and the scattering material may have a different birefringence from each other, and at least one component selected from the group consisting of the transparent resin and the scattering material may comprise a birefringent material. The difference in birefringence index between the transparent resin and the scattering material may be about 0.01 to 0.2. The ratio of the transparent resin relative to the scattering material may be about 10/90 to 90/10 (weight ratio). As the transparent resin and the scattering material (or scattering component), there may be exemplified a birefringent resin (e.g., a styrenic resin, an aromatic polycarbonate-series resin, an aromatic polyester-series resin, an aromatic polyamide-series resin, a thermoplastic aromatic polyurethane-series resin, a polyphenylene ether-series resin, a polyphenylene sulfide-series resin and a cellulose derivative), a liquid crystalline material, and others. The birefringent resin may comprise a resin having an aromatic ring (for example, a styrenic resin). Further, the liquid crystalline material may comprise a liquid crystalline resin or a liquid crystal-fixed resin. The liquid crystal-fixed resin may be formed with a polymerizable component comprising at least a liquid crystal, for example, may comprise (i) a polymer of a polymerizable liquid crystalline compound, (ii) a polymer of a polymerizable monomer in which a non-polymerizable liquid crystalline compound is fixed, and others.

The structure of the light-scattering layer may be an islands-in-an ocean structure or bicontinuous phase structure formed with the transparent resin and the scattering material. In the light-scattering film, the rectilinear transmittance of the incident light usually exhibits a maximum at an incident angle of about 20 to 89° to the film surface. Moreover, the rectilinear transmittance of the incident light from a direction perpendicular to the film surface is about 0 to 30%, and the rectilinear transmittance of the incident light from an oblique direction having an incident angle of 40 to 70° to the film surface is about 50 to 100%. Incidentally, the light-scattering film may comprise a light-scattering layer alone, or may comprise a transparent support, and a light-scattering layer laminated on at least one side of the support.

The light-scattering film of the present invention comprises a birefringent material as at least one component selected from a transparent resin and a scattering material, and can be produced by subjecting the birefringent material to an orientation treatment. For example, the light-scattering film may be produced by forming a coating layer of a composition containing a transparent resin, and a light-polymerizable component composed of at least a liquid crystal, subjecting the liquid crystal component of the coating layer to an orientation, polymerizing the light-polymerizable component by irradiating an active ray, and fixing the oriented liquid crystal.

The light-scattering film can be utilized for a variety of instruments or apparatus, for example, a liquid crystal display apparatus. The liquid crystal display apparatus usually comprises a liquid crystal cell having a liquid crystal sealed therein, a illuminating means, for illuminating the liquid crystal cell by reflection or emission of a light, disposed behind the liquid crystal cell, and the above-mentioned light-scattering film disposed in the light path in front of the illuminating means.

The optical properties of the light-scattering film of present invention shall now be described. FIGS. 2 to 6 are schematic views showing a structure of a light-scattering film and an optical property thereof schematically. As shown in coordinate axes of FIG. 2, it is assumed that a light-scattering film surface stretching to the X-axial direction and the Y-axial direction is the XY-plane in the light-scattering film of the present invention. It is assumed that one main dielectric constant axis of the XY-plane is the X-axis, and that a main dielectric constant axis of the thickness direction of the light-scattering film is Z-axis.

As shown in FIG. 2, in a light-scattering film comprising a transparent resin (or a transparent matrix resin) 6 and a scattering material (a fine particle) 7 dispersed in the resin, if birefringence is imparted to at least one component selected from the transparent resin 6 and the scattering material (fine particle) 7, an angle of a specific inclined direction on the film surface (XY-plane) forms the boundary of a reverse of magnitude relation between the scattering material and the transparent resin in refraction index in a plane containing the X-axis and Z-axis of the light-scattering film (XZ-plane). That is, as shown in FIG. 3, in the XZ plane, a refraction index distribution of the scattering material 9 and that of the transparent resin 8 are different, the refraction index of the scattering material 7 is crossed with and agrees with that of the transparent resin 6 in a specific angle, and the refraction index of the scattering material and that of the transparent material are different in another angle. That is, as shown in FIG. 5, in the case where a linear polarized light, in which a vibrating (vibration) direction 13 is X-axial direction and a propagating (propagation) direction is Z-axial direction, is incident on the front along an incident direction 11 (incidence at an incident angle 12 perpendicular to the film surface (incident angle θ=0°)), an incident polarized light is scattered because the refraction index of the scattering material 7 is disagree with that of the transparent matrix resin 6 (the refraction index of the scattering material and that of the transparent resin are different). On the other hand, as shown in FIGS. 4 and 6, in the case where a linear polarized light containing a vibrating direction 13 and a propagating direction in the XZ-plane is incident at a specific oblique incident angle 12 along an incident direction 11, the scatteration is minimum because the refraction index of the scattering material is agree with that of the transparent resin, so that the polarized light can be transmitted linearly with hardly scattering. In this manner, due to reversibility of a light path, a light is not scattered in a vibrating direction in which the refraction index of the scattering material is agreed with that of the transparent resin. Incidentally, in FIGS. 5 and 6, a reference numeral 14 shows a range to be inhibit spread of a bottom in scattering distribution (in other words, an angle range in which a scattered light intensity is decreased remarkably as compared to a conventional scattering).

Therefore, a light is scattered on an oblique direction in a conventional light-scattering film, on the other hand, a light is not scattered on an oblique direction in which refraction indexes are crossed in a light-scattering film of the present invention, so that directivity can be enhanced. Further, in the case where a linear polarized light is incident at an incident angle smaller than an incident angle with hardly scattering (that is, an incident angle in which a rectilinear transmittance is maximum), the linear polarized light is not scattered in a vibrating direction in which the refraction index of the scattering material is agreed with that of the transparent resin, and is selectively scattered in a direction having larger refraction index differential (difference), that is a front direction perpendicular to the display surface. Therefore, a linear transmitted direction (or a axis of an incident direction) becomes a scattering center part in a conventional scattering film, on the other hand, in the light-scattering film of the present invention, the scattering center part is deviated from a linear transmitted direction to more front direction, and so called off-axis property occurs. By having such an optical characteristic, the light-scattering film realizes that spread of a bottom of light-scatteration in X-axial direction is inhibited in principle, and that off-axis property is imparted to the film in a linear-polarized light of an oblique incidence.

Incidentally, throughout this specification, the term “film” means, without regard to thickness, a two-dimensional material thus meaning a sheet as well. Moreover, a light-scattering film is sometimes referred to as light-diffusing film, and “scattering” is sometimes used as a synonym of “diffusing”.

### BRIEF DESCRIPTION OF THE DRAWINGS

FIG. 1 is a schematic side view showing an apparatus for measuring a rectilinear transmittance.

FIG. 2 is a schematic perspective view showing a light-scattering film along with coordinate axes.

FIG. 3 is a schematic view showing a refraction index distribution of a scattering material and a transparent matrix resin, and a magnitude relation thereof in an XZ-plane of a light-scattering film.

FIG. 4 is a schematic view showing a state that a linear polarized light of an oblique incidence is transmitted linearly with hardly scattering in an XZ-plane of a light-scattering film.

FIG. 5 is a schematic view explaining a scattering of a linear polarized light of an incident light from a front direction in an XZ-plane of a light-scattering film.

FIG. 6 is a schematic view explaining a scattering of a linear polarized light of an oblique incidence in an XZ-plane of a light-scattering film.

FIG. 7 is a graph showing a relationship between an incident angle and a rectilinear transmittance in each of Example 1 and Comparative Example 1.

FIG. 8 is a graph showing a relationship between a scattering angle and a scattering property in each of Example 1 and Comparative Example 1.

FIG. 9 is a graph showing a relationship between a scattering angle and a scattering property in each of Example 2 and Comparative Example 1.

### BEST MODE FOR CARRYING OUT THE INVENTION

[Resin]

A light-scattering layer constituting a light-scattering film may comprise a transparent resin and a scattering material. At least one component selected from the transparent resin and the scattering material is usually formed with a birefringent material. Therefore, an inorganic compound (such as an inorganic particle having high birefringence) may be utilized as the scattering material. In the preferred embodiment, the scattering material also usually comprises a transparent resin (a birefringent resin), and the light-scattering layer usually comprises a plurality of transparent resins varying each other in birefringence. That is, the transparent resin and the scattering material (or transparent resin) comprises a plurality of transparent resins varying each other in birefringence. The difference in birefringence index between the transparent resin and the scattering material (difference in birefringence index of a plurality of resins) is, for example, about 0.01 to 0.2 (e.g., about 0.01 to 0.1), preferably about 0.05 to 0.15 (e.g., about 0.1 to 0.15).

A plurality of resins can be, for example, suitably in combination selected from a styrenic resin, a (meth)acrylic resin, a vinyl ester-series resin (for example, a polyvinyl acetate, an ethylene-vinyl acetate copolymer, a vinyl acetate-vinyl chloride copolymer, a vinyl acetate-(meth)acrylic acid ester copolymer, and a derivative of a vinyl ester-series resin such as a polyvinyl alcohol, an ethylene-vinyl alcohol copolymer and a polyvinyl acetal resin), a vinyl ether-series resin (for example, a homo- or copolymer of a vinyl C₁₋₁₀alkyl ether, a copolymer of a vinyl C₁₋₁₀alkyl ether and a copolymerizable monomer (such as maleic anhydride)), a halogen-containing resin (for example, a polyvinyl chloride, a polyvinylidene fluoride, a vinyl chloride-vinyl acetate copolymer), an olefinic resin (a homopolymer of an olefin such as a polyethylene and a polypropylene, and a copolymer such as an ethylene-vinyl acetate copolymer, an ethylene-vinyl alcohol copolymer, an ethylene(meth)acrylic acid copolymer and an ethylene(meth)acrylic acid ester copolymer), an alicyclic olefinic resin, a polycarbonate-series resin, a polyester-series resin, a polyamide-series resin, a thermoplastic polyurethane-series resin, a polysulfone-series resin (e.g., a polyether sulfone, a polysulfone), a polyphenylene ether-series resin (e.g., a polymer of 2,6-xylenol), a polyphenylene sulfide-series resin, a cellulose derivative (e.g., a cellulose ester, a cellulose carbamate, a cellulose ether), a silicone resin (e.g., a polydimethylsiloxane, a polymethylphenylsiloxane), and a rubber or elastomer (e.g., a diene-series rubber such as a polybutadiene and a polyisoprene, a styrene-butadiene copolymer, an acrylonitrile-butadiene copolymer, an acrylic rubber, a urethane rubber, a silicone rubber).

The styrenic resin includes a homo- or copolymer of a styrenic monomer (e.g. a polystyrene, a styrene-α-methylstyrene copolymer, a styrene-vinyl toluene copolymer) and a copolymer of a styrenic monomer and other polymerizable monomer (e.g., a (meth)acrylic monomer, maleic anhydride, a maleimide-series monomer, a diene). The styrenic copolymer includes, for example, a styrene-acrylonitrile copolymer (AS resin), a copolymer of styrene and a (meth)acrylic monomer [e.g., a styrene-methyl methacrylate copolymer, a styrene-methyl methacrylate-(meth)acrylate copolymer, a styrene-methyl methacrylate-(meth)acrylic acid copolymer], and a styrene-maleic anhydride copolymer. The preferred styrenic resin includes a polystyrene, a copolymer of styrene and a (meth)acrylic monomer [e.g., a copolymer comprising styrene and methyl methacrylate as main component such as a styrene-methyl methacrylate copolymer], AS resin, a styrene-butadiene copolymer and the like.

As the (meth)acrylic resin, a homo- or copolymer of a (meth)acrylic monomer and a copolymer of a (meth)acrylic monomer and a copolymerizable monomer can be employed. As the (meth)acrylic monomer, there may be mentioned, for example, (meth)acrylic acid; a C₁₋₁₀alkyl (meth)acrylate such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate and 2-ethylhexyl (meth)acrylate; an aryl (meth)acrylate such as phenyl (meth)acrylate; a hydroxyalkyl (meth)acrylate such as hydroxyethyl (meth)acrylate and hydroxypropyl (meth)acrylate; glycidyl (meth)acrylate; an N,N-dialkylaminoalkyl (meth)acrylate; (meth)acrylonitrile; a (meth)acrylate having an alicyclic hydrocarbon group such as tricyclodecane. The copolymerizable monomer includes the above styrenic monomer, a vinyl ester-series monomer, maleic anhydride, maleic acid, and fumaric acid. The monomer can be used singly or in combination.

As the (meth)acrylic resin, there may be mentioned a poly(meth)acrylate such as a polymethyl methacrylate, a methyl methacrylate-(meth)acrylic acid copolymer, a methyl methacrylate-(meth)acrylate copolymer, a methyl methacrylate-acrylate-(meth)acrylic acid copolymer, and a (meth)acrylate-styrene copolymer (MS resin). The preferred (meth)acrylic resin includes a methyl methacrylate-series resin comprising methyl methacrylate as main component (about 50 to 100% by weight, and preferably about 70 to 100% by weight).

As the alicyclic olefinic resin, there may be mentioned a homo- or copolymer of a cyclic olefin such as norbornene and dicyclopentadiene (e.g., a polymer having an alicyclic hydrocarbon group such as tricyclodecane which is sterically rigid), a copolymer of the cyclic olefin and a copolymerizable monomer (e.g., an ethylene-norbornene copolymer, a propylene-norbornene copolymer). The alicyclic olefinic resin can be commercially available as, for example, the trade name “ARTON”, the trade name “ZEONEX” and the like.

The polycarbonate-series resin includes an aromatic polycarbonate based on a bisphenol (e.g., bisphenol A) and an aliphatic polycarbonate such as diethylene glycol bisallyl carbonate.

The polyester-series resin includes an aromatic polyester obtainable from an aromatic dicarboxylic acid such as terephthalic acid (a homopolyester, e.g. a polyC₂₋₄alkylene terephthalate such as a polyethylene terephthalate and a polybutylene terephthalate, a polyC₂₋₄alkylene naphthalate, and a copolyester comprising a C₂₋₄alkylene arylate unit (a C₂₋₄alkylene terephthalate unit and/or a C₂₋₄alkylene naphthalate unit) as a main component (e.g., not less than 50% by weight). The copolyester includes a copolyester in which, in constituting units of a polyC₂₋₄alkylene arylate, a part of C₂₋₄alkylene glycols is substituted with a polyoxyC₂₋₄alkylene glycol, a C₆₋₁₀alkylene glycol, an alicyclic diol (e.g., cyclohexane dimethanol, hydrogenated bisphenol A), a diol having an aromatic ring (e.g., 9,9-bis(4-(2-hydroxyethoxy)phenyl)fluorene having a fluorenone side chain, a bisphenol A, bisphenol Aalkylene oxide adduct) or the like, and a copolyester which, in constituting units, a part of aromatic dicarboxylic acids is substituted with an unsymmetric aromatic dicarboxylic acid such as phthalic acid and isophthalic acid, an aliphatic C₆₋₁₂dicarboxylic acid such as adipic acid or the like. The polyester-series resin also includes a polyarylate-series resin, an aliphatic polyester obtainable from an aliphatic dicarboxylic acid such as adipic acid, and a homo- or copolymer of a lactone such as ε-caprolactone. The polyester-series resin may be a crystalline polyester, or non-crystalline polyester. Further, the polyester-series resin may be a liquid crystalline polyester-series resin or liquid crystalline polyester amide-series resin having an aromatic ring.

The polyamide-series resin includes an aliphatic polyamide such as nylon 46, nylon 6, nylon 66, nylon 610, nylon 612, nylon 11 and nylon 12, and an aromatic polyamide obtained from a dicarboxylic acid (e.g., terephthalic acid, isophthalic acid, adipic acid) and a diamine (e.g., hexamethylene diamine, m-xylylenediamine). The polyamide-series resin may be a homo- or copolymer of a lactam such as ε-caprolactam, and is not limited to a homopolyamide but may be a copolyamide. The polyamide-series resin may be a liquid crystalline polyamide-series resin.

Among the cellulose derivatives, the cellulose ester includes, for example, an aliphatic organic acid ester of a cellulose (e.g., a C₁₋₆oraganic acid ester such as a cellulose acetate (e.g., cellulose diacetate, cellulose triacetate), cellulose propionate, cellulose butyrate, cellulose acetate propionate, and cellulose acetate butyrate), an aromatic organic acid ester of a cellulose (e.g. a C₇₋₁₂aromatic carboxylic acid ester such as cellulose phthalate and cellulose benzoate), an inorganic acid ester of a cellulose (e.g., cellulose phosphate, cellulose sulfate), and may be a mixed acid ester such as acetate nitrate cellulose ester. The cellulose derivative also includes a cellulose carbamate (e.g. cellulose phenylcarbamate), a cellulose ether (e.g., cyanoethylcellulose; a hydroxyC₂₋₄alkyl cellulose such as hydroxyethylcellulose and hydroxypropylcellulose; a C₁₋₆alkyl cellulose such as methyl cellulose and ethyl cellulose; carboxymethyl cellulose or a salt thereof, benzyl cellulose, an acetyl alkyl cellulose).

The preferred resin includes, for example, a styrenic resin, a (meth)acrylic resin, a vinyl ester-series resin, a vinyl ether-series resin, a halogen-containing resin, an alicyclic olefinic resin, a polycarbonate-series resin, a polyester-series resin, a polyamide-series resin, a polyurethane-series resin, a polyphenylene ether-series resin, a polyphenylene sulfide-series resin, a cellulose derivative, a silicone-series resin, and a rubber or elastomer, and the like. As a plurality of resins, a resin having the excellent moldability, film-forming (film-formable) property, transparent or weather resistance, for example, a styrenic resin, a (meth)acrylic resin, an alicyclic olefinic resin, a polyester-series resin, a cellulose derivative (e.g., a cellulose ester) is preferred.

In the present invention, usually, the birefringent material may comprise at least one member selected from the birefringent resin and the liquid crystalline material. Therefore, as the birefringent material (or resin), not only the birefringent resin but also a liquid crystalline material (for example, a liquid crystalline resin such as the liquid crystalline polyester-series resin, and a liquid crystal-fixed (or polymerized and fixed) resin can be also utilized. The latter resin can be formed with a polymerizable component (or a polymerizable composition) comprising at least a liquid crystal (or a liquid crystal component). For example, a resin, in which a liquid crystal component is fixed, can be obtained from a polymer produced by polymerizing or crosslinking a polymerizable liquid crystal compound (e.g., a liquid crystal containing a polymerizable (or crosslinkable) functional group such as vinyl group and (meth)acryloyl group) in a liquid crystal state (or directed (oriented) state) with active ray (such as ultraviolet ray) or heat, a polymer produced by polymerizing a mixture of a liquid crystal compound (non-polymerizable liquid crystal compound) and a polymerizable monomer (or polymerizable liquid crystal compound) in a liquid crystal state (or directed (oriented) state) with active ray (such as ultraviolet ray) or heat. Incidentally, a polymerizable liquid crystal component and a polymerizable monomer may be used in combination, or a polymerizable liquid crystal component and a non-polymerizable liquid crystal component may be used in combination. High birefringence is achieved by polymerizing and fixing such a liquid crystal.

Incidentally, as the above-mentioned polymerizable monomer, there may be mentioned the styrenic monomer, the (meth)acrylic monomer, the vinyl ester-series monomer, the vinyl ether-series monomer, the halogen-containing monomer, the olefin, the cyclic olefin, and maleic anhydride. The polymerizable monomer may have one or a plurality of polymerizable group(s). A monomer having a plurality of polymerizable groups includes a bifunctional monomer such as divinylbenzene, an alkylene glycol di(meth)acrylate, a (poly)oxyalkylene glycol di(meth)acrylate, and a di(meth)acrylate of an alkylene oxide adduct of a bisphenol, and polyfunctional monomer such as trimethylol propane tri(meth)acrylate, triallyl isocyanurate, and pentaerythritol tetra(meth)acrylate. Further, a polymerizable oligomer such as an epoxy (meth)acrylate, a polyurethane (meth)acrylate and a polyester (meth)acrylate can be also employed. The monomer may be used singly or in combination. Moreover, on polymerization, a conventional polymerization initiator (e.g., a light-polymerization initiator, an organic peroxide) may be employed.

To provide at least one member among the matrix resin and the scattering material with birefringence, it is preferred to use a birefringent material, for example, a resin in which a birefringent resin or liquid crystal is fixed by polymerization. As the birefringent resin, for example, there may be mentioned a styrenic resin (e.g., a polystyrene, a styrene-acrylonitrile copolymer, a styrene-(meth)acrylic acid copolymer, a styrene(meth)acrylate copolymer), a polycarbonate-series resin (e.g., an aromatic polycarbonate resin such as a bisphenol A-based polycarbonate resin), a polyester-series resin (e.g., a polyalkylene arylate-series resin such as a polyalkylene terephthalate and a polyalkylene naphthalate, a polyarylate-series resin, and an aromatic polyester-series resin such as a liquid crystalline polyester), a polyamide-series resin (e.g., an aromatic polyamide-series resin), a thermoplastic polyurethane-series resin (e.g., a polyurethane-series resin having an aromatic ring), a polyphenylene ether-series resin (e.g., a polymer of 2,6-xylenol), a polyphenylene sulfide-series resin (e.g., a polymer of p-dithiophenol), a cellulose derivative (e.g., a cellulose ester, a cellulose carbamate, a cellulose ether), a silicone resin (e.g., a polymethylphenylsiloxane), and a rubber or elastomer (e.g., a styrene-butadiene copolymer).

Incidentally, a resin having an aromatic ring (such as benzene ring), for example a styrenic resin, has usually high birefringence index. Moreover, birefringence of a resin can be enhanced by orientation treatment (such as deformation orientation by applying stress in molding process) without depending on intrinsic birefringence index of the resin. Therefore, even when a resin having no aromatic ring is used, birefringence index of the resin can be enhanced by treatment such as orientation treatment. In the case where a resin having an aromatic ring (e.g., a styrenic resin) is subjected to orientation treatment, birefringence index of the resin can be further improved.

It is advantageous from the viewpoint of strength and rigidity of a film that a glass transition temperature of at least one resin among constituting resins is not less than 50° C. (e.g., about 70 to 200° C.), and preferably not less than 100° C. (e.g., about 100 to 170° C.). For example, the weight-average molecular weight of the resin can be selected within the range of not more than 1,000,000 (e.g., about 10,000 to 1,000,000), and preferably about 10,000 to 700,000.

Incidentally, in the case where the light-scattering layer comprises a plurality of resins, a plurality of resins may comprise a first resin (e.g., a transparent resin) and a second resin (e.g., a scattering material) in combination. Each of the first resin and the second resin may comprise one resin, or a plurality of resins. The ratio of the transparent resin relative to the scattering material (or the ratio of the first resin relative to the second resin) can be selected from a range of, for example, about 10/90 to 90/10 (weight ratio), preferably about 20/80 to 80/20 (weight ratio), and more preferably about 30/70 to 70/30 (weight ratio). Incidentally, in the case where a film is formed with resins of not less than 3, the content of each resin can be selected from a range of about 1 to 90% by weight (e.g., about 1 to 70% by weight, preferably about 5 to 70% by weight, and more preferably about 10 to 70% by weight).

[Phase Separation Structure]

The phase structure of the above-mentioned light-scattering layer is not particularly limited, and may be an islands-in-an ocean structure (or fine particle-dispersed structure), in which one component among a matrix resin and a scattering material (in particular, a resin) constitutes a matrix (continuous structure) and the other component is dispersed in the matrix in the form of a fine particle, a bicontinuous phase structure, in which both of a matrix resin and a scattering material (in particular, a resin) form a continuous phase and it is impossible to recognize both of the components to be the matrix or the scattering material, or a structure, in which an islands-in-an ocean structure and a bicontinuous phase structure are mixed. Incidentally, using the first resin and the second resin in a suitable ratio by volume (e.g., a substantially approximate equal ratio by volume, such as 60/40 to 40/60 (volume ratio)) and utilizing a spinodal decomposition method can form the bicontinuous phase structure. As the spinodal decomposition, dry spinodal decomposition which comprises inducing phase separation in a resin composition layer (or a coating layer) containing the above-mentioned component(s) by heating, wet spinodal decomposition which comprises inducing phase separation by evaporating a solvent from a resin composition layer (or a coating layer) containing the above-mentioned component(s) and the solvent can be utilized.

The structure of the light-scattering layer may be a three-dimensionally isotropic structure, or may be a uniaxially anisotropic structure which is directed (or oriented) to any one of directions (such as rod-like, rugby ball-like (spheroid-like), and disc-like), a biaxially anisotropic structure (a structure in which any cross-sectional structures of XY-, YZ-, and XZ-plane differ from each other), and others.

[Refraction Index, Scattering]

The light-scattering layer depress a rectilinear transmittance by scattering to a linear polarized light of an incidence from a front direction, in which X-direction is a vibrating direction, and has optical characteristics in which the scattering is minimum and the rectilinear transmittance is maximum at a specific incident angle. In the light-scattering layer, an incident angle in which the rectilinear transmittance is maximum is, for example, 20 to 89°, preferably about 30 to 80° (e.g., about 30 to 70°), more preferably about 40 to 70°, and in particular, about 50 to 70°.

Incidentally, regarding an oblique incidence at an angle of 30° on a film surface, in the case where the light-scattering film of the present invention is utilized as an off-axis scattering film, it is preferred that an incident angle in which the rectilinear transmittance is maximum is, for example, about 40 to 70° (e.g., about 40 to 60°), and preferably about 50 to 60°.

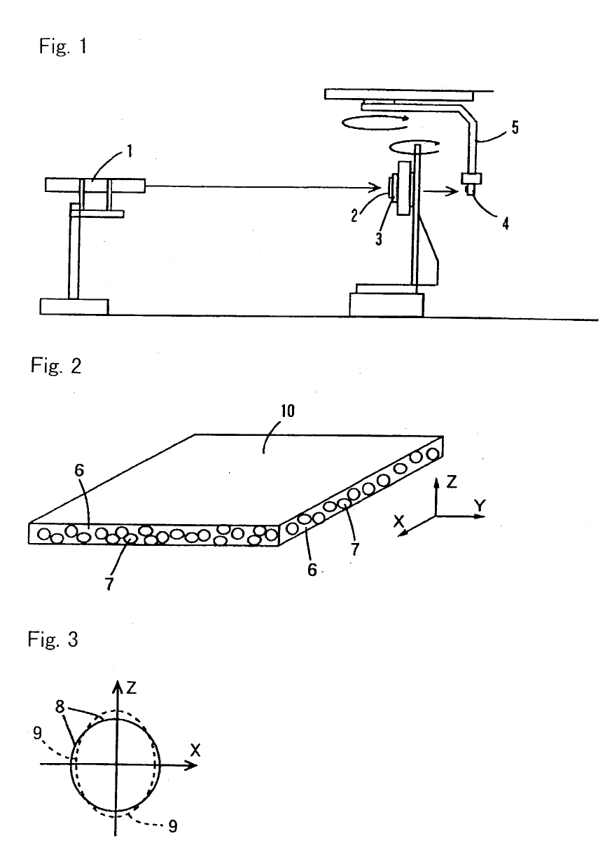

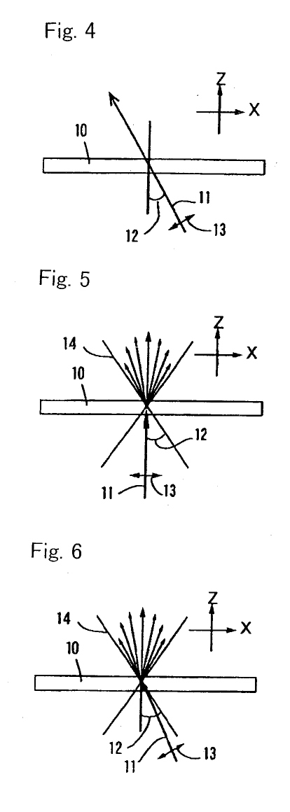

Incidentally, a rectilinear transmittance means a ratio of a linear light (ray) relative to an incident light. For example, the rectilinear transmittance can be measured with a scattering-measuring instrument shown in FIG. 1 (manufactured by Chuo Seiki, Co., Ltd.). This measuring instrument comprises a light source unit 1 capable of emitting a parallel light ray (laser beam), a sample stand 2 capable of putting a sample (light-scattering film) 3 thereon, and a light-receiving unit 4 capable of receiving a light ray from the light source unit 1 and composed of a photodiode. Incidentally, the sample stand 2 is rotatable. Further, a light ray emitted from the light source unit 1 turns into a linear polarized light, in which the vibrating direction is perpendicular to the horizontal direction, by means of a linear polarizer with which an exit of the unit is equipped. Further, the light-receiving unit 4 can be disposed on a light path of a laser beam, and disposed on backside or front side of the sample stand 2 by rotation of an arm 5. In such an instrument, an intensity of transmitted light “A” transmitted linearly to the film is detected by the photodiode, at any incident angle by disposing the light-receiving unit 4 on a light path in backside of the sample stand 2 and setting a rotation angle of the sample stand 2 optionally. Then, by using a transparent glass plate having a refraction index on an equality with the light-scattering film instead of the light-scattering film, an intensity of transmitted light “B” transmitted linearly to the glass plate is determined. In consideration of the transmitted light decay due to interfacial reflection of the light-scattering film, the rectilinear transmittance at any incident angle is calculated based on the following formula:

Rectilinear transmittance (%)=100×A/B

The total light transmittance (transparency) of the light-scattering film is, for example, about 70 to 100%, preferably about 80 to 100%, and more preferably about 90 to 100%. Incidentally, the total light transmittance can be measured by means of a hazeometer (manufactured by Nippon Densyoku Kogyo Co. Ltd., NDH-300A) by regarding the transparent glass plate as a reference. The difference between the total light transmittance and the rectilinear transmittance corresponds to a scattered light component. Therefore, when the rectilinear transmittance is low (e.g., 0 to 50%), the scattered light intensity is high, on the contrary, the rectilinear transmittance is high (e.g., 50 to 100%), the scattered light intensity is low.

In the light-scattering film of the present invention, the rectilinear transmittance to an incidence from a front direction to a film surface (an incidence from a direction perpendicular to a film surface) is, for example, about 0 to 50% (e.g., about 0 to 30%), preferably about 0 to 20% (e.g., about 5 to 20%), and more preferably about 0 to 10%. The rectilinear transmittance to an oblique incidence (for example, an incident light from an oblique direction having an incident angle of 40 to 70° to a film surface) is, for example, about 50 to 100% (e.g., about 50 to 90%), preferably about 60 to 100% (e.g., about 60 to 90%), and more preferably about 70 to 100% (e.g., about 80 to 100%) as the maximum value.

Incidentally, the light-scattering film may comprise a light-scattering layer alone, and may be a laminated film depending on application manner. The laminated film may be a laminated film comprising a support [e.g., a transparent support (a support (substrate) sheet or film) and/or a reflective support], and a light-scattering layer laminated on at least one side of the support. That is, for example, in reflective liquid crystal display apparatus, when the light-scattering film is integrated with a reflecting means, a laminated film comprising the reflecting means and the light-scattering film may be used. In the reflective and backlight-mode (or transmissive) liquid crystal display apparatus, when the light-scattering film is disposed in a light path, a laminated film comprising the transparent support and the light-scattering film may be used, and a laminated film in which at least two kinds of light-scattering layers (or light-scattering film) are laminated may be used. Moreover, two above-mentioned light-scattering layers or light-scattering films, if necessary through the transparent support, may be laminated.

As a resin constituting the transparent support (support sheet), the resin similar to that of the light-scattering layer can be used. As the preferred resin constituting the transparent support, there may be mentioned, for example, a cellulose derivative (e.g., a cellulose acetate such as cellulose triacetate (TAC) and cellulose diacetate), a polyester-series resin (e.g., a polyethylene terephthalate (PET), a polybutylene terephthalate (PBT), a polyarylate-series resin), a polysulfone-series resin (e.g., a polysulfone, a polyethersulfone (PES)), a polyether ketone-series resin (e.g., a polyether ketone (PEK), a polyether ether ketone (PEEK)), a polycarbonate-series resin (PC), a polyolefinic resin (e.g., a polyethylene, a polypropylene), a cyclic polyolefinic resin (e.g., ARTON, ZEONEX), a halogen-containing resin (e.g., vinylidene chloride), a (meth)acrylic resin, a styrenic resin (e.g., a polystyrene), a vinyl ester or vinyl alcohol-series resin (e.g., a polyvinyl alcohol). The transparent support may be stretched monoaxially or biaxially, and may be isotropic optically. The transparent support may be a support sheet or film having low birefringence index or high birefringence index.

As the reflective support, there may be mentioned, for example a light-reflective metal foil such as aluminum foil, silver foil and gold foil, a light-reflective metal plate such as aluminum plate, a metal-vapor deposition plate in which the metal is vapor deposited on a substrate (e.g., plastic, cellamic, substrate made of a metal), a metal-vapor deposition layer composed of the metal and the like. The metal-vapor deposition layer may be formed on a surface of the light-scattering layer or the light-scattering film.

The thickness of the light-scattering layer or the light-scattering film may be, for example, about 1 to 500 μm, preferably about 10 to 200 μm (e.g., about 10 to 100 μm), and more preferably about 10 to 50 μm. Incidentally, when the light-scattering film comprises the support and the light-scattering layer, the thickness of the light-scattering layer may be, for example, about 1 to 70 μm (e.g., about 5 to 50 μm), and preferably about 10 to 50 μm.

Incidentally, the light-scattering layer or the light-scattering film of the present invention may be laminated on, for example, a member constituting a liquid crystal display apparatus (in particular, an optical member) such as a polarizing plate or an optical retardation plate for coloration and high-definition of a liquid crystal image, if necessary.

The light-scattering film may contain a variety of additives, for example, a stabilizer (e.g. antioxidant, ultraviolet absorber, heat stabilizer, etc.), a plasticizer, a colorant (a dye or a pigment), a flame retardant, an antistatic agent and a surfactant. Moreover, if necessary, various coating layers, such as an antistatic layer, an antifogging layer and a parting (release) layer, may be formed on the surface of the light-scattering film.

[Production Process]

Differently from a particle-dispersed light-scattering film, according to the light-scattering film of the present invention, a form (or shape) of a scattering material (e.g., the form such as a fine particle), and a distribution of refractive index to Y-axial direction are not particularly limited. That is, the light-scattering film of the present invention comprises a birefringent material (such as the above-mentioned birefringent material) as at least one component selected from a transparent resin and a scattering material (such as a scattering fine particle), and can be produced by subjecting the birefringent material to an orientation treatment. The orientation treatment includes, for example, a method which comprises applying a stress to a thickness direction of the film to a precursor film composed of a birefringent material as at least one component selected from a transparent resin (such as a transparent matrix resin) and a scattering material (such as a scattering fine particle) by stretching treatment (e.g., uniaxially stretching to X-axial direction, biaxially stretching to X-axial and Y-axial directions), heat pressing treatment, and others. The stretching factor (multiples) is about 1.1 to 10, and preferably about 1.5 to 8 concerning each of stretching directions.

Further, the light-scattering film may be obtained by forming a film or coating layer of a composition containing a transparent resin and a polymerizable component composed of at least liquid crystal, allowing the liquid crystal component of the film or coating layer to orientation, polymerizing the light-polymerizable component with active ray or heat, and fixing thus orientated liquid crystal. As described above, the polymerizable component composed of the liquid crystal can comprise a polymerizable liquid crystal component, a non-polymerizable liquid crystal component, a polymerizable monomer, and the like suitably in combination. For example, the light-scattering film can be obtained by applying a voltage to a precursor film (or a coating layer) in which a polymerizable liquid crystal compound is dispersed (e.g., dispersed in a droplet state) in a transparent resin (matrix resin), or a precursor scattering film (or a coating layer) composed of a transparent resin, a liquid crystal compound, and if necessary a polymerizable monomer, to a thickness direction thereof, to orient the liquid crystal to the thickness direction, and then fixing a oriented state of the liquid crystal compound by a method such as light-polymerization (polymerization by irradiating an active ray such as a ultraviolet ray) and thermal-polymerization.

[Application]

The light-scattering film of the present invention can be utilized for any optical instrument, apparatus, and others, which require a directivity or off-axis property. The light-scattering film of the present invention is useful as a light-scattering film for a backlight unit of a display apparatus, in particular a liquid crystal display apparatus being in need of directivity (e.g., a transmittable liquid crystal display apparatus), and as a transmittable light-scattering film for a reflective liquid crystal display apparatus. In particular, it is advantageous that the light-scattering film of the present invention is used in combination with a polarizing plate.

A liquid crystal display apparatus comprises a liquid crystal cell having a liquid crystal sealed therein, a illuminating means, for illuminating the liquid crystal cell by reflection or emission of a light, disposed behind the liquid crystal cell, and the above-mentioned light-scattering film disposed in the light path in front of the illuminating means.

More specifically, a backlight-mode (or transmittable) liquid crystal display apparatus comprises a liquid crystal cell having a liquid crystal sealed therein, and a flat or plane light source unit (or a backlight unit), for illuminating the liquid crystal cell, disposed behind the liquid crystal cell. The flat light source unit comprises, for example, a tubular light source such as a fluorescence tube (cold cathode tube), the light guide for emitting a light from the tubular light source to a direction of the liquid crystal cell disposed adjacent to the tubular light, and a reflector disposed opposite to the liquid crystal side of the light guide.

In such a liquid crystal display apparatus or a plane light source unit, since a light from the tubular light source is reflected by the reflector and guided by the light guide to uniformly illuminating the liquid crystal cell from behind, one or more light-scattering film(s) is/are usually disposed through a light path (an emission path from the tubular light source) between the tubular light source and the liquid crystal cell (in particular, between the light guide and the liquid crystal cell). The position to be disposed of the light-scattering film is not particularly limited, and for example, can be selected from between the light guide and the liquid crystal cell, on the front side of the light guide, on the reverse side of the liquid crystal cell, on the front side of the liquid crystal cell, and others.

The reflective liquid crystal display apparatus comprises a reflecting means, in particular a reflecting means and a polarizing means. The reflective liquid crystal display apparatus is not limited to a one polarizing plate-mode reflective LCD apparatus with one polarizing plate, and may be a two polarizing plates-mode reflective LCD apparatus with two polarizing plates varying in polarizing property. The reflective LCD apparatus utilizing one polarizing plate may be a reflective LCD apparatus combining one polarizing plate with a variety of modes (e.g. the mode using a twisted nematic liquid crystal, a R-OCB (optically compensated bend) mode, a parallel alignment mode, etc.). Further, the light-scattering film of the present invention can be also applied to a reflective LCD apparatus utilizing the wavelength selectivity in the reflection property of a chiral nematic liquid crystal.

The reflective liquid crystal display apparatus comprises a liquid crystal cell having a liquid crystal sealed therein, a reflecting means, for reflecting an incident light, disposed behind the liquid crystal cell, and the above-mentioned light-scattering film disposed in front of the reflecting means. In a display apparatus comprising such a composition, brighter display of the display surface is realized by disposing at least one above-mentioned light-scattering film into a light path of an incident light (incident path and emerge path) to enter and emit an incident light into the light-scattering layer. It is sufficient that one above-mentioned light-scattering film is disposed into the light path, for example, between the reflecting means and the liquid crystal cell, on the reverse side of the liquid crystal cell, on the front side of the liquid crystal cell, on the front surface of the reflecting means, and others. Moreover, in the case where a polarizing plate is disposed in the front of the liquid crystal cell, the light-scattering film may be disposed between the liquid crystal cell and the polarizing plate.

In such a reflective LCD apparatus, an incident light from the viewer side is transmitted and diffused through the light-scattering film and reflected by the reflecting means, and the reflected light is transmitted and rescattered through the light-scattering film. Therefore, even in the reflective LCD apparatus having the light-scattering film, the display screen can be lightened due to high directivity, the sufficient brightness can be ensured even in color display, and the sharp color image can be realized in the color display-mode reflective LCD apparatus.

Incidentally, in the reflective liquid crystal display apparatus, the position for disposing the light-scattering film is not particularly limited as far as a reflecting means for reflecting an incident light is disposed toward back side of the liquid crystal cell and the light-scattering film is disposed in front of the reflecting means. Moreover, it is sufficient that the polarizing plate may be disposed into a light path (incident path and emerge path). The position for disposing the polarizing means and the light-scattering film is not particularly limited and the light-scattering film may be disposed forwardly of the polarizing means. In the preferred embodiment, in order to illuminate a display screen by the polarizing means, the polarizing plate is disposed forwardly of the liquid crystal cell, and the light-scattering film is disposed between the liquid crystal cell and the polarizing plate.

The reflecting means can be formed with a thin film such as vapor deposition film made of aluminum, and a transparent substrate, a color filter, a light-scattering film, and a polarizing plate may be laminated with an adhesive layer. That is, the light-scattering film of the present invention may be used with laminating the other functional layer (e.g., a polarizing plate, an optical retardation plate, light-reflecting plate, and a transparent conductive layer). Incidentally, when the reflective LCD apparatus is employed as a monochrome display apparatus, the above color filter is not always required.

Moreover, an optical retardation plate may be disposed in an STN (Super Twisted Nematic) liquid crystal display apparatus, though this is not indispensable in a TFT liquid crystal display apparatus. The optical retardation plate may be disposed on a suitable position, for example, between the front transparent substrate and the polarizing plate. In this apparatus, the light-scattering film may be interposed between the polarizing plate and the optical retardation plate, and may be interposed between the front transparent substrate and the optical retardation plate.

The light-scattering film of the present invention realizes bright display of a display surface by utilizing birefringence. Therefore, the LCD apparatus can be utilized broadly in the display segments of electrical and electronic products such as personal computers, word processors, liquid crystal televisions, cellular phones, chronometers, desktop calculators. Especially, it is preferably utilized in a liquid crystal display apparatus of a portable information terminal.

### INDUSTRIAL APPLICABILITY

According to the light-scattering film of the present invention, transmitting and scattering of an incident light through the use of birefringence realizes that spread of a bottom in distribution of a scattered light intensity is effectively inhibited, and that directivity in a light-scattering property is enhanced. Further, the light-scattering film of the present invention ensures that brightness of a display surface viewed from a front direction is enhanced even in the case where the light is incident from an oblique direction, and that off-axis property of a light-scattering property on an oblique incidence is obtained. Therefore, in the case where the light-scattering film is used in combination with a liquid crystal display apparatus, bright display of the display surface is realized.

### EXAMPLES

The following examples are intended to describe this invention in further detail and should by no means be interpreted as defining the scope of the invention.

### Example 1

A commercially available acrylic liquid crystal compound (polymerizable acrylic liquid crystal) (100 parts by weight) and cyano-series liquid crystal compound (100 parts by weight) were mixed to prepare a liquid crystal mixture. The liquid crystal mixture showed a liquid crystal state at room temperature. The refraction index of the mixture was measured by means of an Abbe refraction index detector, and the birefringence index was 0.18 (ne=1.70, no=1.52). On the other hand, 200 parts by weight of SAN resin (a styrene-acrylonitrile copolymer, manufactured by Technopolymer Co, Ltd., 290ZF, refraction index=1.56) was dissolved in 800 parts by weight of cyclohexane, and to thus obtained solution was mixed the liquid mixture and 2 parts by weight of a polymerization initiator (a light-polymerization initiator). After mixing, thus obtained solution showed transparent isotropic phase. The solution was coated on a transparent conductive layer (ITO)-attached glass plate, and dried at room temperature for 30 minutes. The solution was blenched (or whitened) with drying, and made into a white-turbid (clouded) scattering layer after drying. The scattering layer was dried in an oven at 100° C. for 1 hour to remove cyclohexanone, then a transparent conductive layer or membrane (ITO)-attached glass plate was also adhered to the surface of the scattering layer. Incidentally, the thickness of the scattering layer after drying was 30 μm.

When examined with a light microscope, the scattering layer was found to have a bicontinuous phase separation structure due to spinodal decomposition. The transparent conductive layer (ITO)-attached glass plates disposed above and below the scattering layer were applied a volt alternating current having frequency of 1 kHz to make orientation of the liquid crystal, and in the state, the layer was subjected to irradiation of ultraviolet ray from one side thereof to fix orientation of the liquid crystal by applying the voltage. Thereafter, the ITO-attached glass plates were separated from the scattering layer to finally obtain a light-scattering film having a thickness of 30 μm.

### Comparative Example 1

In ethyl acetate was dissolved 63 parts by weight of PMMA (a poly(methyl methacrylate), manufactured by Mitsubishi Rayon Co., Ltd., BR-80) and 37 parts by weight of SAN resin (a styrene-acrylonitrile copolymer, manufactured by Technopolymer Co, Ltd., 290ZF) to prepare a 10% by weight solution. Thus obtained solution was flow-cast on a glass plate to form a transparent layer 14 μm thick, and the layer was subjected to thermal treatment in an oven at 220° C. for 20 minutes to obtain a light-scattering film. The layer was clouded, and when examined with a transmission light microscope, the layer was found that a phase separation structure had a bicontinuous structure. The layer was separated from the glass plate to obtain a light-scattering film.

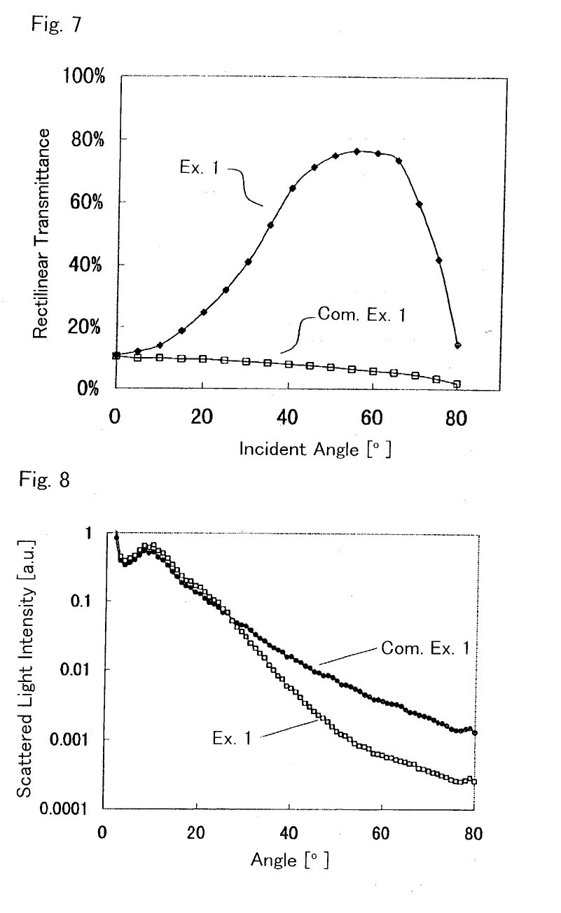

By using the apparatus shown in FIG. 1, irradiation and receiving of a light were conducted while an incident angle of a linear polarized light was varied by rotating the sample stand 3, and a relation between an incident angle and a rectilinear transmittance was determined about light-scattering films of Example 1 and Comparative Example 1. The results are shown in FIG. 7. As shown in FIG. 7, the light scattering film of Example 1 has maximum of the rectilinear transmittance in an oblique incident direction.

Further, the sample stand 3 was rotated in order that an incident light comes from a front side, then irradiation of a linear polarized light was conducted, the light was received with rotating the arm 5, and a scattering properties on the scattering angles in the front incidence was determined. The results are shown in FIG. 8. The light-scattering film of Example 1 is inhibited a bottom of scattering to an oblique direction in distribution of a scattered light intensity, and the scattered intensity of a small angle side (not more than about 30°) is larger than that of the light-scattering film of Comparative Example 1.

### Example 2

A light-scattering film 80 μm thick was produced as the same manner as in Example 1. Incidentally, the sample stand 3 was rotated so that an oblique incident angle was 30° on the film surface by using the apparatus shown in FIG. 1, then an irradiation of a polarized light was conducted and received, and a rectilinear transmittance at 30° of an oblique incident light of the light-scattering film was measured as 10%.

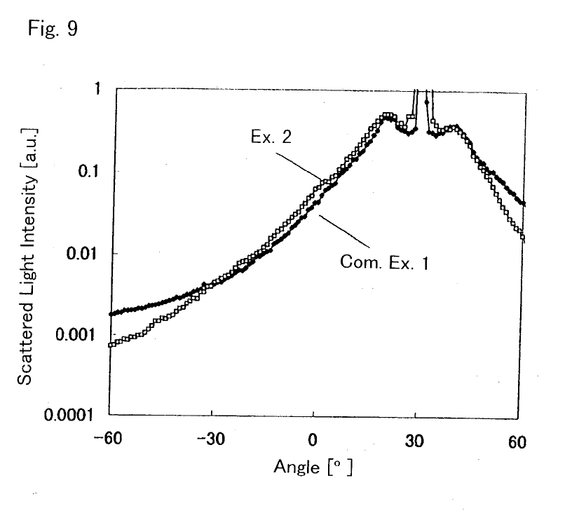

Furthermore, each of the light-scattering films obtained from Example 2 and Comparative Example 1 was attached to the sample stand 3 by rotating the sample stand 3 at an oblique incident angle of 30°, then irradiating a linear polarized light, and receiving the light with rotating the arm 5, a scattering property relative to a scattering angle at an incident light of 30° was determined. The results are shown in FIG. 9. Incidentally, in the Example, a scattering angle corresponding to a linearly transmitted direction is 30°. As apparent from FIG. 9, in the case of the light-scattering film of Example 2, the distribution of scattering is deviated to the front direction as compared to the light-scattering film of Comparative Example 1 (that is, the former film has off-axis property). Therefore, the light-scattering film is suitable for use of a reflective liquid crystal display apparatus in which a light irradiation is conducted from an oblique direction of the display and the display is viewed at the front (the direction at an angle of 0°).

1. A light-scattering film comprising a light-scattering layer containing a transparent resin and a scattering material, wherein a rectilinear transmittance of an incident light exhibits a maximum at an oblique incident direction to the film surface when a linear polarized light, in which a vibrating direction and a propagating direction exist in a plane containing an axis of a surface direction of the film and an axis of a thickness direction of the film, is incident on the film surface.

2. A light-scattering film according to claim 1, wherein a plurality of transparent resins forming the transparent resin and the scattering material have a different birefringence from each other.

3. A light-scattering film according to claim 2, wherein the difference in birefringence index between the transparent resin and the scattering material is 0.01 to 0.2.

4. A light-scattering film according to claim 2, wherein the weight ratio of the transparent resin relative to the scattering material is 10/90 to 90/10.

5. A light-scattering film according to claim 1, wherein at least one component selected from the group consisting of the transparent resin and the scattering material comprises a birefringent material.

6. A light-scattering film according to claim 5, wherein the birefringent material comprises at least one member selected from the group consisting of a birefringent resin and a liquid crystalline material.

7. A light-scattering film according to claim 6, wherein the birefringent resin comprises at least one member selected from the group consisting of a styrenic resin, an aromatic polycarbonate-series resin, an aromatic polyester-series resin, an aromatic polyamide-series resin, a thermoplastic aromatic polyurethane-series resin, a polyphenylene ether-series resin, a polyphenylene sulfide-series resin and a cellulose derivative.

8. A light-scattering film according to claim 6, wherein the birefringent resin comprises a resin having an aromatic ring.

9. A light-scattering film according to claim 8, the resin having an aromatic ring comprises a styrenic resin.

10. A light-scattering film according to claim 6, wherein the liquid crystalline material comprises a liquid crystalline resin or a liquid crystal-fixed resin.

11. A light-scattering film according to claim 10, wherein the liquid crystal-fixed resin is formed with a polymerizable component comprising at least a liquid crystal.

12. A light-scattering film according to claim 1, wherein the transparent resin comprises a resin having an aromatic ring, the scattering material comprises at least one member selected from the group consisting of (i) a polymer of a polymerizable liquid crystalline compound, and (ii) a polymer of a polymerizable monomer in which a non-polymerizable liquid crystalline compound is fixed.

13. A light-scattering film according to claim 1, wherein the transparent resin and the scattering material form an islands-in-an ocean structure or bicontinuous phase structure in the light-scattering layer.

14. A light-scattering film according to claim 1, wherein the rectilinear transmittance of the incident light exhibits a maximum at an incident angle of 20 to 89° to the film surface.

15. A light-scattering film according to claim 1, wherein the rectilinear transmittance of the incident light from a direction perpendicular to the film surface is 0 to 30%, and the rectilinear transmittance of the incident light from an oblique direction having an incident angle of 40 to 70° to the film surface is 50 to 100%.

16. A light-scattering film according to claim 1, which comprises a transparent support, and a light-scattering layer laminated on at least one side of the support.

17. A process for producing a light-scattering film, wherein at least one component selected from the group consisting of a transparent resin and a scattering material comprises a birefringent material, and the process comprises subjecting the birefringent material to an orientation treatment to obtain a light-scattering film forming a light-scattering layer having a light-scattering property recited in claim 1.

18. A process according to claim 17, which comprises forming a coating layer of a composition containing a transparent resin, and a light-polymerizable component composed of at least a liquid crystal, subjecting the liquid crystal of the coating layer to an orientation, polymerizing the light-polymerizable component by irradiating an active ray, and fixing the oriented liquid crystal.

19. A liquid crystal display apparatus, which comprises
a liquid crystal cell having a liquid crystal sealed therein,
a illuminating means, for illuminating the liquid crystal cell by reflection or emission of a light, disposed behind the liquid crystal cell, and
a light-scattering film recited in claim 1 disposed in the light path in front of the illuminating means.

20. A liquid crystal display apparatus according to claim 19, wherein a polarizing plate is disposed in front of the liquid crystal cell, and the light-scattering film recited in claim 1 is disposed between the liquid crystal cell and the polarizing plate.
